(19) United States
(12) Patent Application Publication
(10) Pub. No.: US 2015/0212800 A1
(43) Pub. Date: Jul. 30, 2015

(54) METHOD AND APPARATUS FOR GENERATING SYMBOL IN HIGH LEVEL PROGRAMMING LANGUAGE

(71) Applicant: Samsung Electronics Co., Ltd., Suwon-si (KR)

(72) Inventors: Seyoung OH, Suwon-si (KR); Tushar VRIND, Suwon-si (KR)

(21) Appl. No.: 14/603,627

(22) Filed: Jan. 23, 2015

(30) Foreign Application Priority Data
Jan. 29, 2014 (KR) 10-2014-0011647

(51) Int. Cl. G06F 9/44

(52) U.S. Cl. CPC G06F 8/31

(57) ABSTRACT

A method for generating a symbol in a programming language is provided. The method includes declaring a variable in a header file, generating a first file including an instruction to include the header file and including a function referring to the declared variable, generating a second file including an instruction to include the first file, and compiling the second file.

### CROSS-REFERENCE TO RELATED APPLICATION(S)

This application claims the benefit under 35 U.S.C. §119(a) of a Korean patent application filed on Jan. 29, 2014 in the Korean Intellectual Property Office and assigned Serial number 10-2014-0011647, the entire disclosure of which is hereby incorporated by reference.

### TECHNICAL FIELD

The present disclosure relates to a method and an apparatus for generating a symbol in a high level programming language. More specifically, the present disclosure relates to a method and an apparatus for generating the symbol to have a visibility scope in a module level in a high level programming language.

### BACKGROUND

High level programming languages including C, JAVA, Basic, FORTRAN and Pascal have configurations closer to human language than machine language, and thus are easily written, understood and maintained in a program. Such high level programming languages are translated into a machine language using a compiler, an interpreter, and the like, and are executed. In such high level programming languages, methods of designating a memory area of a variable may be diversely classified when accessibilities thereof are set as a criterion. As an example, memory areas in C language include “auto,” “register,” “static,” and “extern.” First, the “auto” is called an automatic variable or a local variable, and is stored in “stack.” When a specific block is executed, an area of memory is allocated, and when the corresponding block is terminated, the area of memory is deallocated. In general, the indicator named “Auto” in a block may be omitted. When the variable named “register” is declared, not an area of memory but the “register” is allocated. In more detail, the “register” is a storage device which is different from a Read-Only Memory (ROM) or a Random-Access Memory (RAM) and is closest to the interior of a Central Processing Unit (CPU). Therefore, the “register” has fastest but has a small amount of memory. When the “register” is declared in C language, a value is stored in not the memory but the “register”, so that speed may be improved. However, when the “register” is declared, the value is not unconditionally allocated to the “register.” The value is allocated only when there are some spaces according to a use situation of a current register. When no empty register exists, the value is allocated to the “stack.” A variable declared as a “static” is stored in a “Data Segment.” The variable is generated when a program is executed, and is maintained until the program is terminated. A global variable is also stored in the “Data Segment.” The “Extern” is declared outside a function, and is stored in the “Data Segment.” The “Extern” exists on a predetermined area until a program is terminated, which is similar to the static variable. The “Extern” is a variable which has the broadest effective area among variables and which is used not only in a current code but also in all linked programs.

Although such a memory area may be allocated according to use thereof, when a plurality of modules constitute a program, it is necessary to declare a variable having a global scope accessible only by a module of a program. When a plurality of files constitute a module, if a variable is declared in the plurality of files included in the module, it is necessary that a variable having a global scope exists in the plurality files constituting the module, and such a necessity increases more and more in view of fluidity or security of a program.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for, when a high level language configures a module using a plurality of files, generating a variable such that a part of the files may access a global area and other files cannot access the global area, thereby improving the efficiency and the security of the entirety of a program.

In accordance with an aspect of the present disclosure, a method for generating a symbol in a programming language is provided. The method includes declaring a variable in a header file, generating a first file including the header file and including a function referring to the declared variable, generating a second file including the first file, and compiling the second file.

In accordance with another aspect of the present disclosure, an apparatus for generating a symbol using a program language is provided. The apparatus includes a storage unit that stores a file, and a controller configured to control the storage unit, to declare a variable in a header file, to generate a first file including the header file and referring to the declared variable, to generate a second file including the first file, and to compile the second file.

In accordance with another aspect of the present disclosure, a non-volatile memory apparatus for a programming language is provided. The non-volatile memory apparatus storing a computer program includes declaring a variable in a header file, generating a first file including the header file and referring to the declared variable, generating a second file including the first file, and compiling the second file.

According to an embodiment of the present disclosure, a programming language declares a variable which a plurality of files in a module may access like a global variable and an external module cannot access, thereby ensuring the efficiency and the security of a structure of a program.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a structure in which each module accesses a variable according to an embodiment of the present disclosure;

FIG. 2 illustrates a structure in which a variable is accessed between files in a module according to an embodiment of the present disclosure;

FIG. 3 illustrates a structure in which a variable having a range of a global area is accessed within a module according to an embodiment of the present disclosure;

FIG. 4 is a flowchart illustrating a method of generating a program according to an embodiment of the present disclosure;

FIG. 5 is a flowchart illustrating a file processing method of generating a program according to an embodiment of the present disclosure;

FIG. 6 illustrates a code of a program according to an embodiment of the present disclosure; and

FIG. 7 is a block diagram illustrating components of a device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Further, in the description of an embodiment of the present disclosure, a method in which C language is used as an example of a high level programming language is disclosed. However, this example is for the convenience of the description, and the same method and the same apparatus may be applied even to cases using different high level programming languages.

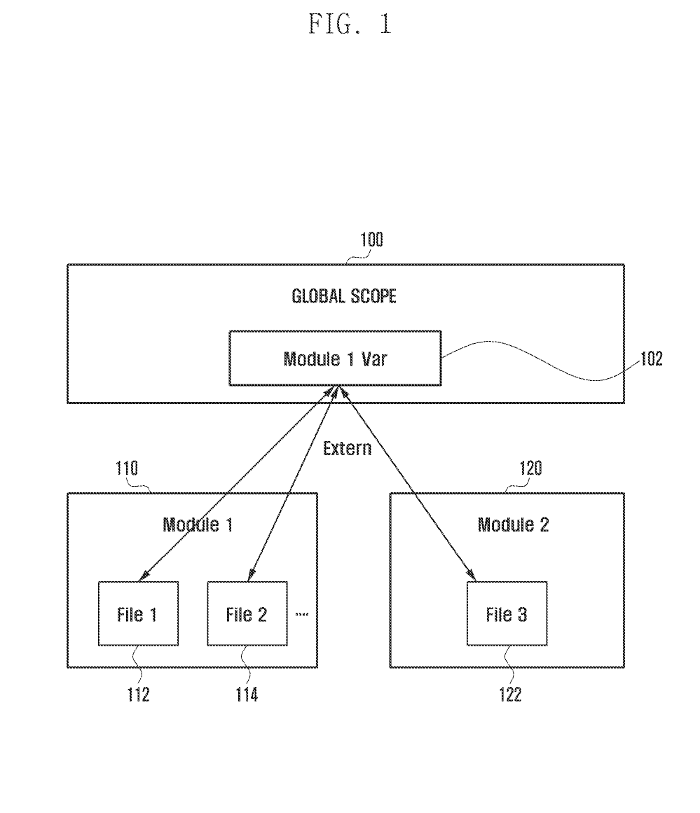

FIG. 1 illustrates a structure in which each module accesses a variable according to an embodiment of the present disclosure.

Referring to FIG. 1, in an embodiment, a variable 102 for a module 1 110 may be declared in a global scope 100. The variable 102 for the module 1 may be configured as a global scope, and may be declared using an “Extern” according to an embodiment.

A program according to an embodiment may include the module 1 110 and a module 2 120, and each module may include one or more files. In more detail, the module 1 110 may include one or more of a file 1 112 and a file 2 114, and the module 2 120 may include a file 3 122.

In an embodiment, the variable 102 for the module 1 is declared to be accessible from the files included in the module 1 110, and has a global scope, thereby being also accessible from the module 2 120.

In this case, modules other than the module 1 110 may also read or write the variable 102 for the module 1. In this case, accessibility may be improved, but security may be reduced.

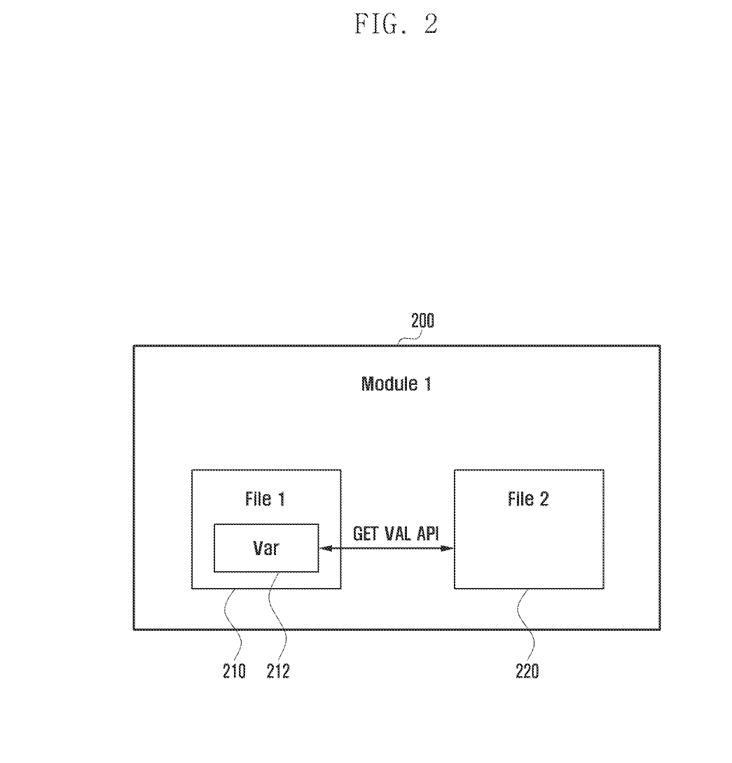

FIG. 2 illustrates a structure in which a variable is accessed between files in a module according to an embodiment of the present disclosure.

Referring to FIG. 2, a module 1 200 according to an embodiment may include a file 1 210 and a file 2 220. In order to declare a variable 212 available in a module, the variable may be declared as “static” in the file 1 210. Further, “GET VAL API” may be used in order to refer to the variable 212 in the file 2 220.

In this case, although the variable 212 cannot be accessed from the outside the module, an additional code for bringing the variable such as “GET VAL API” is required.

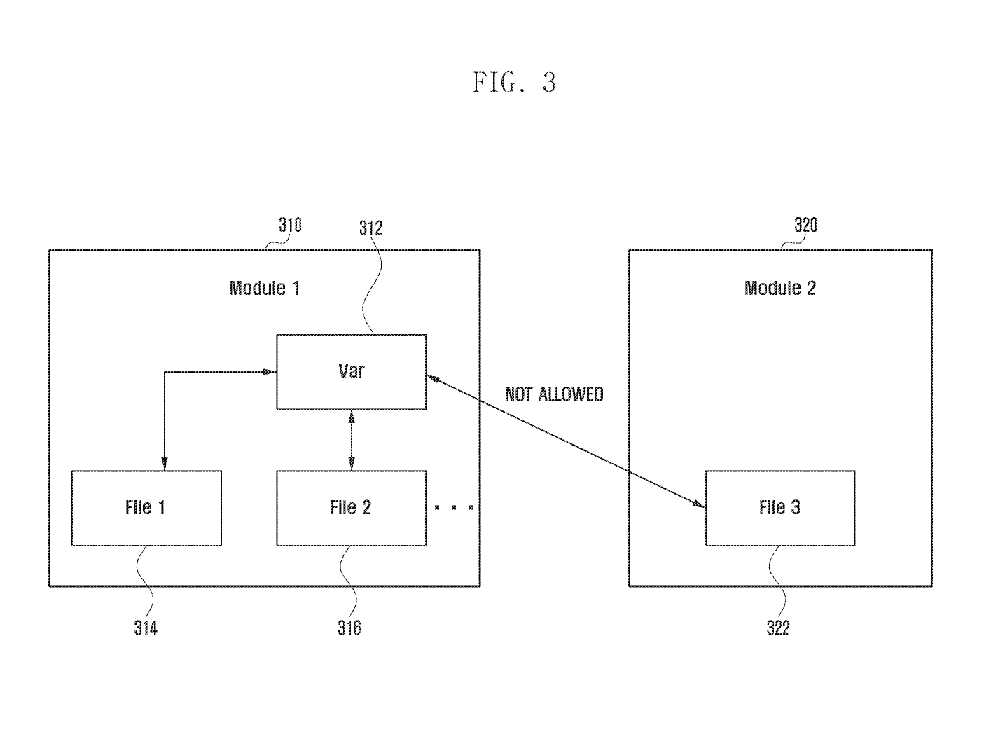

FIG. 3 illustrates a structure in which a variable having a range of a global area is accessed within a module according to an embodiment of the present disclosure.

Referring to FIG. 3, a module 1 310 may include a plurality of files, and in an embodiment, may include a file 1 314 and a file 2 316. Further, a variable 312, which is accessible to each file in the module, may be declared. When a variable having such a structure is declared, files included in the module 1 310 may access the variable 312, but files outside the module 1 310 cannot access the variable 312. In an embodiment, a program written in a file 3 322 of a module 2 320 cannot access the variable 312, so that security may be maintained. Further, a code included in a file in the same module may access the variable 312, so that usability may be improved. In an embodiment, such a variable may be referred to as a module-specific global variable, and such a variable may be accessed from the same module, which is like a global variable, but cannot be accessed from the outside the module. In an embodiment, the same module may include a code included in the plurality of files. Further, in a file system, files of the same module may be included in the same folder.

In an embodiment, file 1 314 (i.e., “Foo1.c”) and file 2 316 (i.e., “Foo2.c”) may be included in the module 1 310. The file 1 314 and the file 2 316 may access “var” 312, but file 3 322 (i.e., “Foo3.c) of the module 2 320 cannot access the “var” 312.

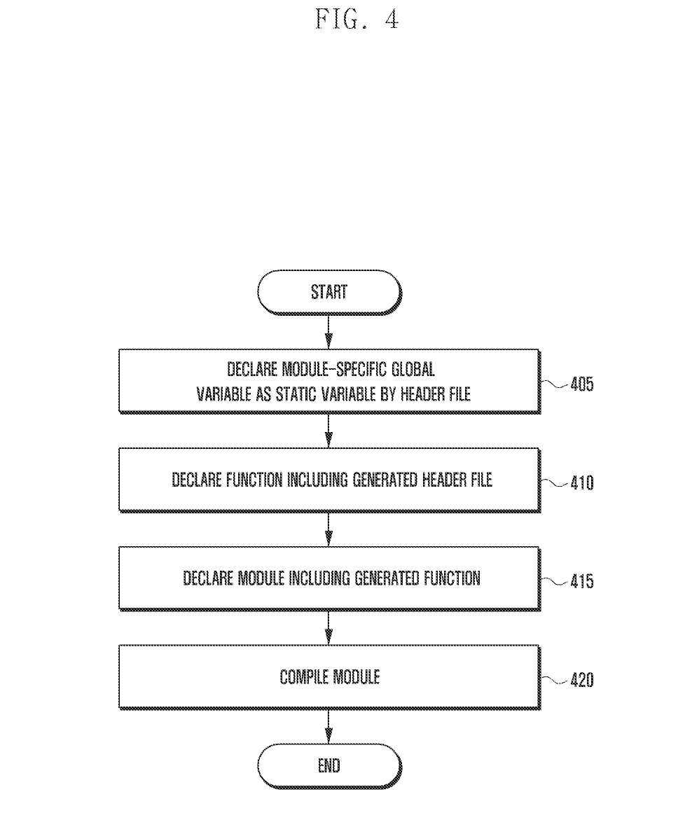

FIG. 4 is a flowchart illustrating a method of generating a program according to an embodiment of the present disclosure.

Referring to FIG. 4, in operation 405, a system may declare a module-specific global variable in a header file. In more detail, the module-specific global variable may be declared as a static variable.

In operation 410, the system may declare a function in a file including the header file. Further, the function may perform at least one of referring and changing of a module-specific global variable declared in the header file. Further, in later operations, one or more files included in the same module may refer to or change the module-specific global variable declared in the header file.

In operation 415, the system may declare a module including a file in which a function is declared. In more detail, the module may be located in the same folder where the declared file is located. Further, in accordance with an embodiment, the module may include one or more of files in which functions are declared, and may not include a code content other than the files.

In operation 420, the system may compile the file including the declared module. Through the above process, the file included in the module may access the module-specific global variable declared in the head file.

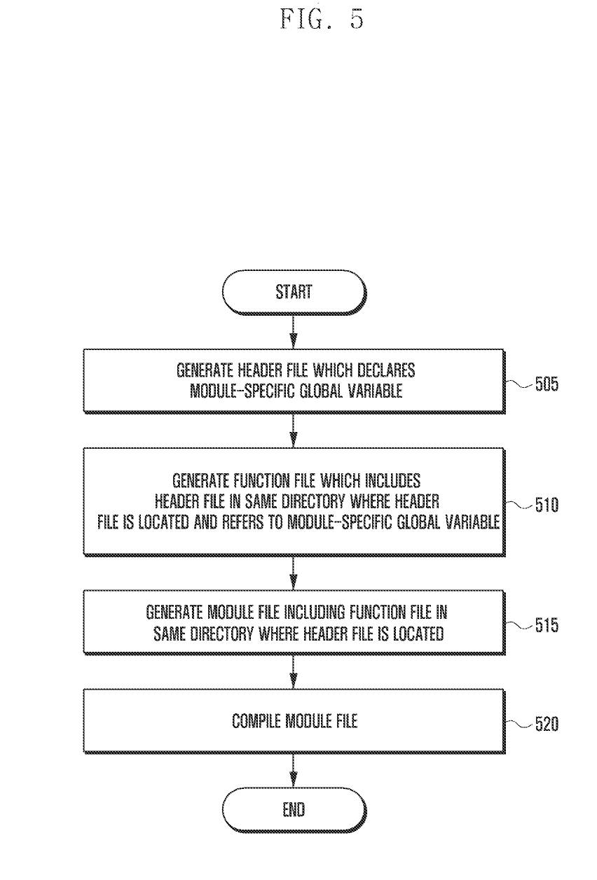

FIG. 5 is a flowchart illustrating a file processing method of generating a program according to an embodiment of the present disclosure.

In operation 505, a system may generate a header file in which a module-specific global variable is declared. In an embodiment, the module-specific global variable declared in the generated header file may be declared as a static variable.

In operation 510, the system may generate a file which is located in the same directory where the header file is located, includes the header file, and includes a function referring to the module-specific global variable. In an embodiment, a code having a different form, which refers to the module-specific global variable other than the function, may be declared. Further, in accordance with an embodiment, the system may generate one or more of files including a function referring to the module-specific global variable.

In operation 515, the system may generate a module file including the file including the function in the same directory where the file including the header file and the function is located. In accordance with an embodiment, the module file may be configured by only a code including the file including the function.

In operation 520, the system may compile the module file. Through such a process, the file including the function may access the module-specific global variable, and files other than the module file cannot access the module-specific global variable.

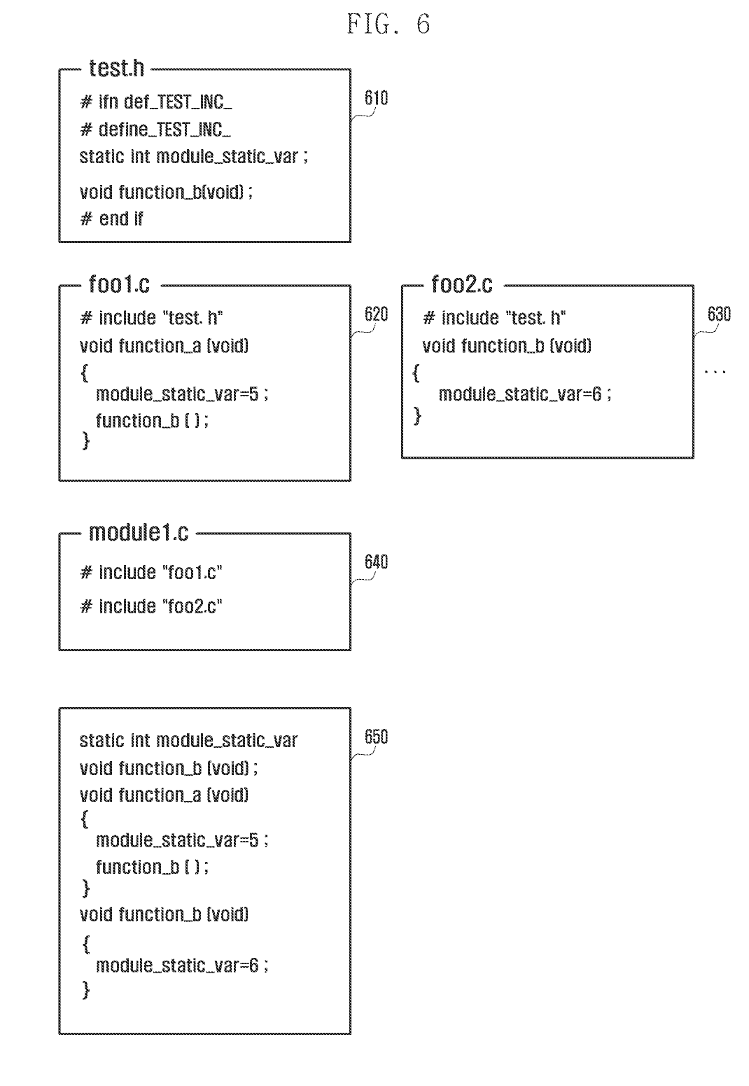

FIG. 6 illustrates a code of a program according to an embodiment of the present disclosure.

Referring to FIG. 6, in reference numeral 610, “test.h” may be declared as a header file.

In the “test.h,” 610 a module global variable may be declared as “module_static_var,” and a memory area may be “static.”

A form of a variable may be a form other than “int.” Further, in the header file, a function to be used in future may be declared. In an embodiment, “function_b” is declared. In an embodiment, it is possible to declare one or more module global variables.

In each of reference numerals 620 and 630, a function referring to the module global variable may be declared. In “foo1.c” 620 and “foo2.c” 630, the function referring to the module global variable may be declared, and a file in which the function referring to the module global variable is declared may include the “test.h” 610, which is a header file in which the module global variable is declared. Further, the “foo1.c” 620 and the “foo2.c” 630 may be located on the same folder where the “test.h” 610 corresponding to the header file is located. Further, in an embodiment, the function “function_a” referring to the module global variable may be declared in the “foo1.c”, and the function “function_b” referring to the module global variable may be declared in the “foo2.c” 630.

In reference numeral 640, “module1.c”, which is a module file including the files in which the functions are declared, may be generated. In an embodiment, “module1.c” 640 may be located on the same folder where the header file and the file in which the function is declared are located. Further, in an embodiment, the module file may be configured by only a code which includes the declared function. The module file may be generated through a script automatically including a C file in the same folder or through a “makefile” of a module level.

In this way, when a module-specific global variable is declared in a header file, a file including a function which needs to access the module-specific global variable is located on the same folder where the header file is located, and a module file including the file including the function which needs to access the global variable is generated so that the module file is complied, the function of the file included in each module file may access the module-specific global variable declared in the header file.

When the module file is complied, a code indicated by reference numeral 650 may be compiled. A compiling process of an embodiment may be changed such that the “makefile” includes only “module.c.” 640. Through such a process, “test.h” 610 may be included only once during the compiling process. Thus, the module-specific global variable may be also declared only once, and the functions declared in “foo1.c” and “foo2.c” may refer to the module-specific global variable.

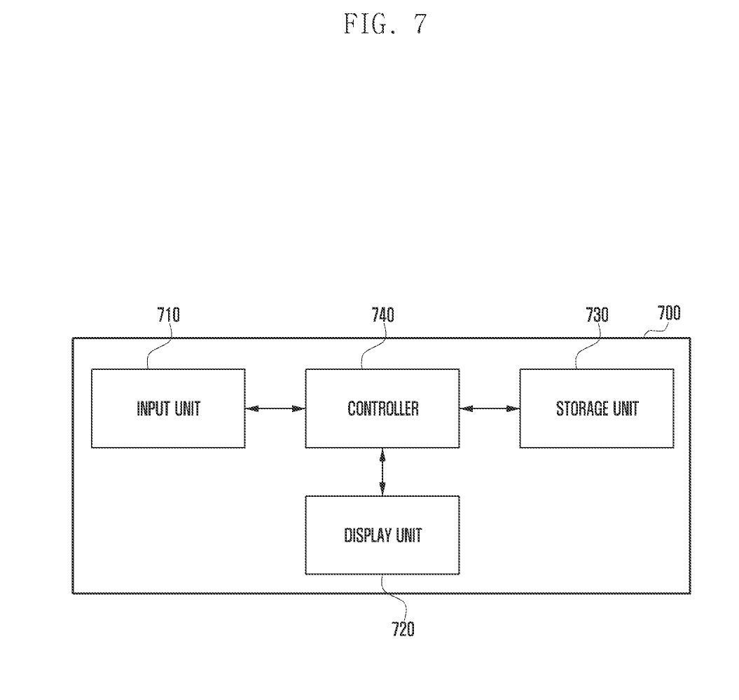

FIG. 7 is a block diagram illustrating components of a device according to an embodiment of the present disclosure.

Referring to FIG. 7, another device 700 according to an embodiment may include an input unit 710, a display unit 720, a storage unit 730 and a controller 740. The configuration of the embodiment may be selective, and may include a part of the components or other components according to the device in which a code is executed.

The input unit 710 according to an embodiment may receive an input of a user. The input may include one or more of an input for coding and an input for compiling.

The display unit 720 according to an embodiment may display necessary information according to an operation of the device 700.

The storage unit 730 according to an embodiment may store necessary information according to an operation of the device 700.

The controller 740 according to an embodiment may control an overall of the components, execute the code, and compile the code.

Various aspects of the present disclosure may also be embodied as computer readable code on a non-transitory computer readable recording medium. A non-transitory computer readable recording medium is any data storage device that may store data which may be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium may also be distributed over network coupled computer systems so that the computer readable code is stored and executed in a distributed fashion. Also, functional programs, code, and code segments for accomplishing the present disclosure may be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include ROM, RAM, CD-ROMs, magnetic tapes, floppy disks, and optical data storage devices. Also, functional computer programs, instructions, and instruction segments for accomplishing the present disclosure may be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for generating a symbol in a programming language, the method comprising:
declaring a variable in a header file;
generating a first file including an instruction to include the header file and including a function referring to the declared variable;
generating a second file including an instruction to include the first file; and
compiling the second file.

2. The method of claim 1, wherein the declaring of the variable comprises declaring the variable as a static memory region variable.

3. The method of claim 1, further comprising:
generating a third file including an instruction to include the header file and including a function referring to the declared variable,
wherein the second file includes an instruction to include the first file and the third file.

4. The method of claim 1, wherein the compiling of the second file comprises compiling the header file, the first file, and the second file in the same directory.

5. The method of claim 1, wherein the compiling of the second file comprises executing an instruction to include the header file once.

6. The method of claim 1, wherein the generating of the second file comprises generating the second file by using a script including an instruction to include all of files each including a function compiled in a directory in which the second file is compiled.

7. The method of claim 1, further comprising:
generating a fourth file including a function which does not allow access of the declared variable, in a directory different from that of the first file,
wherein the second file includes an instruction to include the first file and the fourth file.

8. An apparatus for generating a symbol using a program language, the apparatus comprising:
a storage unit for storing a file; and
a controller configured:
to control the storage unit, declares a variable in a header file,
to generate a first file including an instruction to include the header file and referring to the declared variable,
to generate a second file including an instruction to include the first file, and
to compile the second file.

9. The apparatus of claim 8, wherein the controller is further configured to declare the variable as a static memory region variable.

10. The apparatus of claim 8,
wherein the controller is further configured to generate a third file including an instruction to include the header file and referring to the declared variable, and
wherein the second file includes an instruction to include the first file and the third file.

11. The apparatus of claim 8, wherein the controller is further configured to compile the header file, the first file, and the second file in the same directory.

12. The apparatus of claim 8, wherein the controller is further configured to execute an instruction to include the header file once.

13. The apparatus of claim 8, wherein the controller is further configured to generate a second file by using a script including an instruction to include all of files each including a function compiled in a directory in which the second file is compiled.

14. The apparatus of claim 8,
wherein the controller is further configured to generate a fourth file including a function not allowing access of the declared variable, in a directory different from that of the first file, and
wherein the second file includes an instruction to include the first file and the fourth file.

15. The apparatus of claim 8, wherein another file includes an instruction to include the first file and the second file.

16. A non-volatile memory apparatus for a programming language, the non-volatile memory apparatus storing a computer program comprising:
declaring a variable in a header file;
generating a first file including an instruction to include the header file and referring to the declared variable;
generating a second file including an instruction to include the first file; and
compiling the second file.
